(19) United States
(12) Patent Application Publication
(10) Pub. No.: US 2009/0049673 A1
(43) Pub. Date: Feb. 26, 2009

(54) PROCEDURE FOR THE MANUFACTURE OF A JOINING DEVICE FOR SHUTTERING PANELS AND THE DEVICE PRODUCED IN ACCORDANCE WITH SAID PROCEDURE

(75) Inventor: Pedro Xammar Bove, Barcelona (ES)

Correspondence Address: SUGHRUE MION, PLLC, 2100 PENNSYLVANIA AVENUE, N.W., SUITE 800, WASHINGTON, DC, 20037, US

(73) Assignee: INVERAL, S.A., BARCELONA (ES)

(21) Appl. No.: 12/282,580

(22) PCT Filed: Mar. 9, 2007
(86) PCT No.: PCT/EP2007/002090

§ 371 Date: Sep. 11, 2008

(30) Foreign Application Priority Data
Mar. 28, 2006 (ES) P200600803

(51) Int. Cl. B23P 11/00; E04G 17/04

(52) U.S. Cl. 29/437; 29/283

(57) ABSTRACT

A joining device for shuttering panels which features a clamp, supported by a hollow tubular body, manually operable by means of a lever which is articulately joined to the tubular body by means of an articulated joint, the device being equipped with a regulating system which allows said articulated joint to be moved longitudinally along the interior of the tubular body, which incorporates a closing cover of said tubular body equipped with a central hole; a regulating nut, equipped with an operating head and an internally threaded hollow rod which is inserted into the tubular body through the hole in the closing cover; and a bracing bush which prevents the removal of the hollow rod from the interior of the tubular body, the regulating nut being joined to the closing cover by the outward splaying of the mouth of the hollow rod.

### TECHNICAL FIELD OF THE INVENTION

This invention relates to a procedure for the manufacture of a joining device for shuttering panels of the clamp-shaped type, equipped with two jaws, mounted on a supporting part, and an operating lever by means of which the clamp is operated so that its jaws change from the open position to the operational closed position, wherein both jaws are locked on the end ribs of two respective juxtaposed panels in the operative closed position and vice versa.

### BACKGROUND OF THE INVENTION

Currently, various types of device for joining shuttering panels together, commonly called shuttering clamps, are widely used, for example when the vertical shuttering for a concrete wall is assembled.

Document ES 2 046 935 B1 discloses a clamp-shaped joining device for shuttering panels is known, equipped with two jaws mounted on a supporting part. One of the jaws is solidly joined to the supporting part, while the other jaw, called moving jaw, is sliding, it being possible to axially move the same along said supporting part, it being guided along a section of the same. In short, the moving jaw is solidly attached to a tubular body which envelops the supporting part, which is also tubular.

The supporting part is tubular and hollow, and is transversally intersected by a pin whose ends protrude through their respective mounting holes made on opposite sides of the supporting part. The aforementioned ends of the pin are articulately joined to the ends of a fork which is solidly joined to a lever equipped with a handgrip for the manual operation of the joining device. The fork, joined to the lever, and the tubular body, solidly joined to the moving jaw, are linked, by means of two lateral arms, one on each side, by way of connecting rods, whose ends are articulated on their respective kingpins.

On manual operation of the lever, which pivots on the pin, the lateral arms or connecting rods transform the turning movement of the lever into a longitudinal movement of the moving jaw, moving it closer to or further from the fixed jaw, according to the direction of the turning movement carried out, the device thus adopting the closed or open position, respectively.

The part of the pin which is inside the supporting part is surrounded by a bush which in turn is joined to a rod equipped with a threaded end on which a regulating nut is screwed, said nut protrudes outside the supporting part through a hole provided in a cover which closes one end of the supporting part. The regulating nut, whose movement is limited so that it may only turn with regard to the closing cover of the tubular support, is operated manually and is intended to axially move, when rotated, the threaded rod and therefore the bush and the pin, within the limits imposed by the dimensions of the mounting holes. A spring is located around the rod, with one end resting against the cover of the tubular supporting part and the other end resting on the aforementioned bush.

The position of the pin with regard to the turning pivots may be adjusted at the will of the user by means of turning the regulating nut in order to establish thus the extent of the movement of the jaw and to increase or to reduce the force necessary to operate the device.

In practice, the regulating nut is equipped with a head at one end and a hollow cylindrical section, threaded internally, into which the end of the rod, which is connected to the pin around which the lever turns, is screwed. The cylindrical section of the regulating nut is inserted into the supporting part through the hole in the cover which closes one of the ends of the supporting part, the head of the nut being on the outside of said cover. A cylindrical bush, which surrounds the cylindrical section of the regulating nut, is welded to the section of the nut which is inserted into the supporting part, preventing its removal from the supporting part but allowing the nut to turn around its axis. To this end, the outside diameter of the bush is greater than that of the hole in the cover.

Due to the small dimensions of the supporting part, it is not possible to weld the sleeve to the nut when the closing cover is positioned and welded in place on the supporting part; for this reason it is necessary to carry out the assembly of the nut, the cover and the sleeve prior to positioning and fixing the cover on the supporting part. Once the cover has been welded on the supporting part, and on completion of all the operations which require welding, the resulting assembly is subjected to an anti-corrosion treatment, such as galvanising or zinc-plating, in order to prevent its deterioration due to rusting with the passage of time.

However, due to the fact that the cylindrical section of the regulating nut is housed inside the supporting part, when the assembly is subjected to the anti-corrosion treatment, said treatment does not reach the internal area of the hollow cylindrical section of the nut; for this reason the internal threading of said hollow cylindrical section is not adequately protected. In consequence, on using the clamp in external surroundings or exposed to the elements, the internal thread deteriorates rapidly with time, preventing the turning of the regulating nut with regard to the rod, and therefore the movement of the rod along the interior of the supporting part. In short, it is not possible to regulate the necessary force for operation of the clamp.

In order to overcome this drawback, the solution of subjecting the operating nut to an anti-corrosion treatment at a stage prior to assembly of the cover on the tubular body is not totally satisfactory, as once the cover is welded onto the supporting part, and on completion of all the operations which require welding, the resulting assembly must be subjected to an anti-corrosion treatment in order to prevent its deterioration, said treatment usually including the step of the immersion of the object to be treated in an acid solution. These acids eliminate, from the surfaces which come into contact with said acids, the result of a previous anti-corrosion treatment, eliminating in this case the protection of the internal thread of the operating nut. That is to say, that although the nut may be subjected to a prior anti-corrosion treatment, said treatment would be eliminated by the acids used in the subsequent treatment. Likewise, replacing the regulating nut with a nut of a corrosion-resistant material, such as brass or stainless steel, increases excessively the cost of the device as well as worsening the machineability of the components and impairing the finish of the device.

Another drawback of the device described above is that on welding the bush onto the cylindrical section of the regulating nut, the latter is slightly distorted due to the effect of the heat and due to the reduced thickness of its walls, its internal section also being distorted, which adversely affects the assembly by screwing of the rod. Once again, the turning of the regulating nut on the aforementioned rod and the regulation of the necessary force to operate the clamp is hindered.

### Explanation of the Invention

With the object of providing a solution to the drawbacks described above, a new procedure is disclosed for the manufacture of a joining device for shuttering panels of the type which features a clamp, supported on a hollow tubular body, closed by means of a cover at one of its ends at least, which can adopt the respective open and closed positions by the manual operation of a lever which is articulately joined to the device by means of an articulated joint housed inside the tubular body, the device being provided with a regulating system which allows said articulated joint to be moved longitudinally along the interior of the tubular body by operation of a regulating nut, equipped with an operating head and an internally threaded hollow rod assembled, so as to permit the turning of the same, on one of the covers which close the tubular body.

In essence, the procedure of the invention is characterised in that it includes the steps for subjecting the regulating nut to an anti-corrosion treatment: positioning the closing cover at one of the open ends of the hollow tubular body and joining the two by means of welding: inserting the hollow rod of the regulating nut, which has previously been subjected to the anti-corrosion treatment, through a hole featured in the closing cover; inserting a bracing bush, of a diameter greater than that of the hole in the closing cover, into the tubular body through the end opposite to that which features the aforementioned closing end cover, so that the hollow rod of the regulating nut passes through said bush, and splaying the mouth of the hollow rod outwards so that the bush is embedded, with a certain amount of play, between the internal surface of the cover and the splayed mouth of the hollow rod.

In accordance with another characteristic of the procedure, said procedure also comprises the step of subjecting the assembly formed by the tubular body and the closing cover, joined together by welding, to an anti-corrosion treatment prior to the insertion of the rod of the regulating nut into the hole of the aforementioned closing cover.

According to another aspect of the invention, a joining device for shuttering panels is disclosed, which comprises a clamp, supported by a hollow tubular body, closed at one of its ends at least, by means of a cover which features a central hole, the clamp being able to adopt the open and closed positions by means of the manual operation of a lever which is articulately joined to said device by means of an articulated joint housed within the tubular body, the device being equipped with a regulating system which allows the longitudinal movement of said articulated joint along the interior of the tubular body.

The device is characterised in that the regulating system comprises a regulating nut subjected to an anti-corrosion process and which features an operating head and an internally threaded hollow rod, which is inserted into the aforementioned tubular body through the central hole in the closing cover, and a bracing bush, of a diameter greater than that of the hole in the closing cover, which prevents the removal of the hollow rod from the interior of the tubular body, the regulating nut being joined to the closing cover by splaying the mouth of the hollow rod outwards, the bracing bush being fixed in place between the internal surface of the closing cover and the splayed mouth of the hollow rod.

In accordance with another characteristic of the device, the assembly formed by the tubular body and the cover is also subjected to an anti-corrosion treatment.

### BRIEF DESCRIPTION OF THE DRAWINGS

The attached drawings illustrate, as a non-limitative example, a preferred embodiment of the joining device for shuttering panels manufactured in accordance with the object of the invention. In said drawings:

FIG. 1 is a partially sectional elevational view of the regulating system of a joining device in accordance with the invention;

FIG. 2 is an exploded perspective view of the regulating system and of the device in FIG. 1, and

FIG. 3 is a perspective view of the assembly formed by a regulating nut, a closing cover and a bracing bush, arranged to be installed on the supporting part of a joining device which forms part of the state of the art.

### DETAILED DESCRIPTION OF THE DRAWINGS

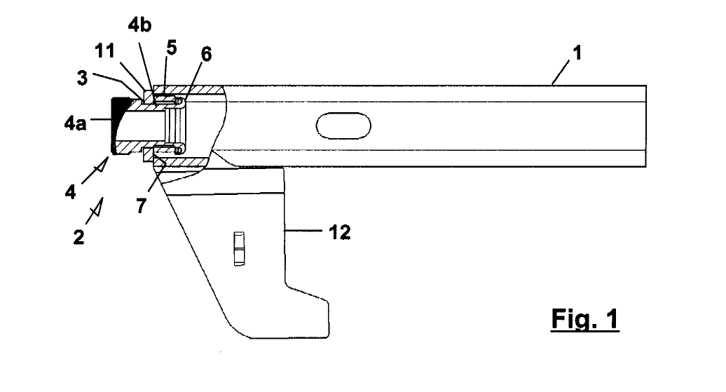

In FIG. 1, only part of a joining device for shuttering panels of the type equipped with a clamp which may adopt an open position or a closed position has been portrayed. Specifically, said FIG. 1 shows the hollow tubular body 1 which acts as a support for a first fixed jaw 12, whereon a second mobile jaw (not portrayed) moves longitudinally, and which, together with the first jaw form the aforementioned clamp.

One end of the tubular body 1 has been portrayed in section; for this reason the elements housed within said tubular body 1 are visible, in particular the components of the regulating system 2 with which the device is equipped in accordance with the invention.

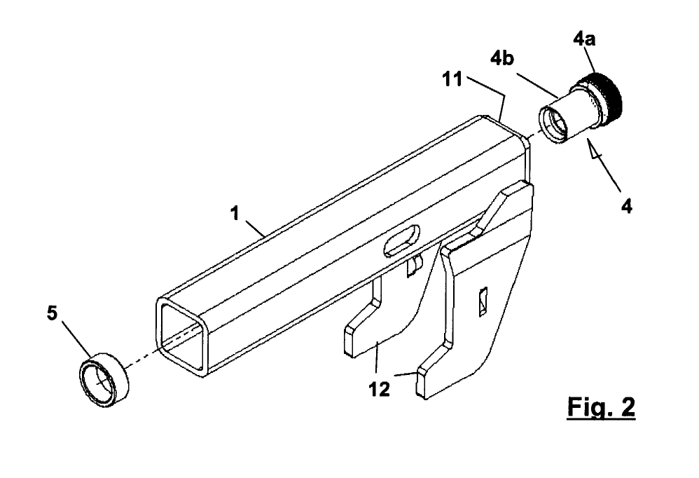

The aforementioned regulating system 2 is comprised in the example of FIGS. 1 and 2 of a regulating nut 4, equipped with an operating head 4a and an internally threaded hollow rod 4b, with a bracing bush 5 and a closing cover 11 of the tubular body 1 to which it is joined by welding.

As may be seen in FIG. 1, the hollow rod 4b of the regulating nut 4 is inserted into the tubular body 1 through a hole 3 with which the closing cover 11 of said tubular body 1 is equipped.

The bush 5, whose outside diameter is greater than the diameter of the hole in the closing cover 11, surrounds the hollow rod 4b of the regulating nut 4 and maintains the join between the regulating nut 4 and the closing cover 11 by means of the splaying of the mouth 6 of the hollow rod. In fact, the bush 5 is retained with a certain amount of play in the position portrayed in FIG. 1, on one side by buffering against the outward splaying of the mouth 6 of the hollow rod 4b of the regulating nut 4, and on the other side by buffering against the internal surface 7 of the closing cover 11. Under these conditions the regulating nut 4 cannot be removed or separated from the tubular body 1 but it can be operated from the outside, by means of the operating head 4a, in order to turn the same around its axis.

The internal thread of the hollow rod 4b is intended to receive, by screwing, one end of a rod (not portrayed), the other end of which is prevented from turning inside the tubular body 1, in such a way that turning the regulating nut causes the longitudinal movement of the second end of the rod along the interior of the hollow body 1. Said rod is attached to a pin around which an operating lever of the moving jaw turns, and in this way the movement of the second end of the rod is transmitted to the pin.

The procedure for assembly of the regulating system 2 disclosed above allows the manufacture of a joining device for shuttering panels with a longer useful life, in particular when the regulating nut 4 and the tubular body 1 are made of a material which requires an anti-corrosion treatment, due to the fact that the procedure allows both the aforementioned regulating nut 4 and the tubular body 1 to be subjected separately to an anti-corrosion treatment before assembly of the device, said device being suitably protected.

In accordance with said procedure, during a first stage the regulating nut 4, equipped with the operating head 4a and the internally threaded hollow rod 4b, is subjected to an anti-corrosion treatment, for example galvanising its surface with a film of zinc by means of electrolytic immersion processes. Likewise, the assembly formed by the tubular section 1 (with its ancillaries such as the fixed jaw 12) and the closing cover 11, once said cover 11 is joined by welding to the aforementioned tubular body 1, is also subjected to an anti-corrosion process.

Subsequently, the hollow rod 4b of the regulating nut 4, after being subjected to the anti-corrosion process, is inserted through the hole 3 with which the closing cover 11 of the tubular body 1 is equipped, said closing cover being joined to the aforementioned tubular body 1 by welding, as portrayed in FIG. 2.

At a subsequent stage, the bracing bush 5, of a diameter greater than that of the hole 3 in the closing cover 11, is inserted into the tubular body 1, through the end opposite to that which is joined to the aforementioned closing cover 11, in such a way that the hollow rod 4b of the regulating nut 4 penetrates through said bush, and the mouth 6 of the hollow rod 4b is splayed outwards, in such a way that the bracing bush 5 is embedded, with a certain amount of play, between the internal surface 7 of the closing cover 11 and the splayed mouth 6 of the hollow rod 4b, as has been explained above.

The resulting assembly requires no further welding operations, and for this reason it is not necessary to subject the same to any further anti-corrosion treatment. All the surfaces of the components of the clamp which take part in this manufacturing procedure are already adequately protected, including the internal thread of the rod 4b of the regulating nut 4.

Unlike current procedures, the fact that the assembly of the regulating system 2 is carried out without using welded joints allows the assembly of the regulating nut 4 after having undergone prior treatment, if necessary, which guarantees the protection of the internal thread of the hollow rod 4b.

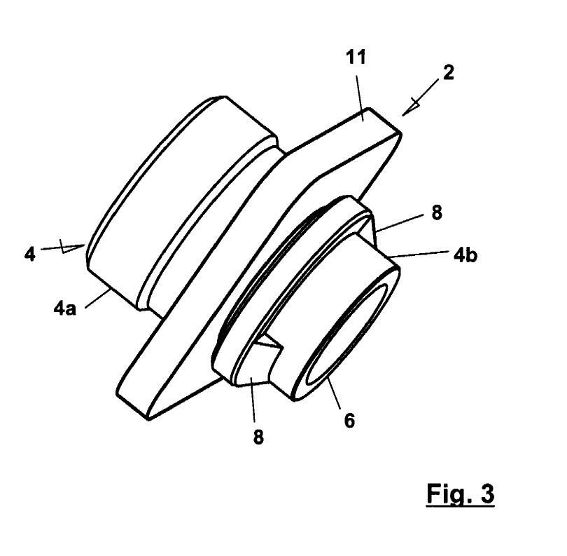

In FIG. 3, a conventional regulating system 2 is portrayed, wherein the bracing bush 5 is welded by means of three spot welds 8 to the hollow rod 4b of the regulating nut 4, an operation which must be carried out prior to welding the closing cover 11 onto the tubular body 1 due to problems of space. Once the closing cover 11 is welded onto the tubular body 1, the welding of the bracing bush 5 cannot be carried out, due to the restricted profile of the tubular body 1, which prevents the access of a normal welding tool to the area to be welded.

On the other hand, the regulating nut cannot be subjected to an anti-corrosion treatment prior to its being joined to the closing cover 11, as the welding of the regulating nut 4 to the bracing bush 5 and of the closing cover 11 to the tubular body 1 still has to be carried out; these are joins which should be suitably protected by subsequently plating the complete assembly with an anti-corrosion treatment, wherein the acids involved will eliminate the protection of the internal thread of the regulating nut 4, which cannot be protected again due to the fact that the treatment does not reach the internal surfaces, such as the aforementioned internal thread of the regulating nut 4. Besides, welded joins between parts which have been subjected to a surface treatment, such as galvanisation, are not advisable, as the quality of the welds does not guarantee does not guarantee an adequate join between said parts.

1. A procedure for the manufacture of a joining device for shuttering panels which comprises a clamp, supported on a hollow tubular body (1), closed by means of a cover (11) at one of its ends at least, which can adopt the respective open and closed positions by means of the manual operation of a lever which is articulately joined to the device by means of an articulated joint housed inside the tubular body, the device being provided with a regulating system (2) which allows said articulated joint to be moved longitudinally along the interior of the tubular body by operation of a regulating nut (4), equipped with an operating head (4a) and an internally threaded hollow rod (4b) assembled, so as to permit the turning of the same, on one of the covers which close the tubular body, characterised in that it comprises the steps of:
a) subjecting the regulating nut to an anti-corrosion treatment;
b) positioning the closing cover at one of the open ends of the hollow tubular body and joining the two by means of welding;
c) inserting the hollow rod of the regulating nut, said nut having been subjected to the anti-corrosion treatment, through a hole (3) with which the closing cover is equipped;
c) inserting a bracing bush (5) of a diameter greater than that of the hole in the closing cover, into the tubular body, through the end opposite to that which is joined to the aforementioned closing cover, in such a way that the hollow rod of the regulating nut penetrates through said bush; and
d) splaying outwards the mouth (6) of the hollow rod, in such a way that the bush is embedded, with a certain amount of play, between the internal surface (7) of the closing cover and the splayed mouth of the hollow rod.

2. A procedure according to the preceding claim, characterised in that it comprises the step of subjecting the assembly formed by the tubular body (1) and the closing cover (11), joined together by welding, to an anti-corrosion treatment prior to the insertion of the rod (4b) of the regulating nut (4) through the hole (3) in the aforementioned closing cover.

3. A joining device for shuttering panels which comprises a clamp, supported by a hollow tubular body (1), closed by means of a cover (11) at one of its ends at least, said cover featuring a central hole (3), the clamp being able to adopt the respective open and closed positions by means of the manual operation of a lever which is articulately joined to said device by means of an articulated joint housed inside the tubular body, the device being equipped with a regulating system (2) which allows said articulated joint to be moved longitudinally along the interior of the tubular body, characterised in that the regulating system comprises:
a regulating nut (4) subjected to an anti-corrosion treatment, and which is equipped with an operating head (4a) and an internally threaded hollow rod (4b), which is inserted into the aforementioned tubular body through the central hole in the closing cover; and
a bracing bush (5), of a diameter greater than that of the hole in the closing cover, which prevents the removal of the hollow rod from the interior of the tubular body, the regulating nut being joined to the closing cover by the outward splaying of the mouth of the hollow rod, the bracing bush being retained between the internal surface of the closing cover and the splayed mouth of the hollow rod.

4. A device according to claim 3, characterised in that the assembly formed by the tubular body (1) and the closing cover (11) are also subjected to an anti-corrosion treatment.
